(19) United States
(12) Patent Application Publication
(10) Pub. No.: US 2002/0089509 A1
(43) Pub. Date: Jul. 11, 2002

(54) Memory device having depth compare-write function and method for depth compare-write used by the memory device

(76) Inventors: Dong-woo Lee, Kyungki-do (KR); Ja-il Koo, Seoul (KR)

Correspondence Address: MARGER JOHNSON & McCOLLOM, P.C., 1030 SW Morrison Street, Portland, OR, 97205, US

(21) Appl. No.: 09/898,699

(22) Filed: Jul. 2, 2001

(30) Foreign Application Priority Data
Jul. 3, 2000 (KR) 00-37769

(51) Int. Cl. G06T 15/40; G09G 5/39

(52) U.S. Cl. 345/531; 345/422

(57) ABSTRACT

A memory device for performing graphics functions, and a method of processing depth data that is received by a memory controller. The memory device includes a memory cell array, and a data modifying circuit. The data modifying circuit includes a register for storing external depth data received from the memory controller. The data modifying circuit also includes a compare circuit which compares the stored external depth data with corresponding internal depth data stored in the memory cell array, and updates the memory cell array accordingly. The compare circuit also outputs status signals, thus reporting to the memory controller whether the data was updated or not. Depending on a first control signal, a control circuit helps the external data be written directly to the memory, bypassing the data modifying circuit. Depending on a second control signal, the comparison is in X bits or NX bits.

This application claims priority from Korean Priority Document No. 00-37769, filed on Jul. 3, 2000 with the Korean Industrial Property Office, which document is hereby incorporated by reference.

### BACKGROUND OF THE INVENTION

1. Field of the Invention

The present invention relates to memory devices, and more particularly, to memory devices having a Z-buffering function and method for depth compare-write used by the memory devices.

2. Description of the Related Art

In two-dimensional (2-D) graphics, an object on a display screen is represented by coordinates X, Y and color. When an existing object is replaced with a new object on a display screen, a color value is recorded at a position of a memory corresponding to coordinates X, Y of each pixel forming the new object, and then the color value is scanned on the display screen. By “object” it is meant a graphics object. The object may be called “new” from the graphics processing, even though it may be the same screen object perceived by the user.

In three-dimensional (3-D) graphics, Z-values represent a pixel's distance from the viewer. Typically, small Z values indicate that an object is close to the viewer, whereas large Z values indicate that the object is far away. In other words, Z-coordinate information determines depth data of an object on a display screen, thus allowing the user to recognize the depth of the object.

Devices that use 3-D graphics employ 3-D functions, which include Z-buffering, α-blending, and texture mapping. Such functions are computation intensive, and thus require a wide bandwidth. In particular, in Z-buffering, in order to perform 3-D graphic applications such as a 3-D game, Z-coordinate information should be added to X- and Y-coordinate information in a 2-D graphic. This serial operation is called Z-buffering.

In such functions, an existing object may be replaced by a new object on a display screen. It may be the same object, but with a new appearance, as would be mandated by the updated Z-coordinates.

Thus, when replacing an existing object with a new object on a display screen, firstly spatial coordinate values (also called Z values or depth data) of pixels are compared which map the existing object, against those which map the new object. Then, if the latter is less than the former, the former is updated with the latter.

Z-buffering is performed by comparing the Z-values of incoming color data with the Z-values of pre-existing color data. If the incoming color data is closer (i.e., it has a smaller Z value), the pre-existing color data is replaced with the incoming color data. Otherwise, the incoming color data is discarded.

In the prior art, this function is performed by the memory controllers. Such a memory controller reads the spatial coordinate values of the pixels of the existing object from a memory device, and compares them with the spatial coordinate values of the pixels of the new object. If there is any modification in the spatial coordinate values of the existing object, then the memory controller writes the spatial coordinate values of the new object to the memory device. This operation is called read-modify-write (hereinafter referred to as “RMW”).

FIG. 1 is a timing diagram for explaining RMW of a conventional memory device. Referring to FIG. 1, if a memory read command RD is input on the rising edge of a clock cycle 3 after an activate command ACT is input from a memory controller, internal depth data Dout stored in a memory cell selected by the read command RD is read by the memory controller through data input/output (I/O) pins DQ.

The memory controller compares spatial coordinate values Dout of an existing object with input spatial coordinate values Din of a new object at intervals “a”. As can be seen from FIG. 1, interval “a” is two cycles long. If the input spatial coordinate values (hereinafter referred to as “external depth data”) Din of the new object are smaller than the spatial coordinate values (hereinafter referred to as “internal depth data”) Dout of the existing object. It means that the object is now closer. The memory controller then prepares for writing the external depth data Din to a memory cell array of the memory device by replacing the internal data. If there is a write command WR, then the external depth data Din standing-by in the data I/O pins DQ is written to the selected memory cell array of the memory device, in response to the write command WR.

As can be seen in FIG. 1, for performing one RMW operation on spatial coordinate values, at least ten clock cycles are required from the point when the activate command ACT is input, until the point when a precharge command PRE may be input. This is because a logic for comparing coordinate values of depth data is included in a memory controller, and a depth compare function is performed by the memory controller of the prior art.

Accordingly, the conventional memory device has a problem in that memory bus performance is degraded. The time taken for performing an RMW operation on spatial coordinate values is delayed, which degrades performance of the graphics functions.

### SUMMARY OF THE INVENTION

To solve the above problems, it is a first objective of the present invention to provide a memory device which can shorten the time taken for modifying and writing spatial coordinate values, so as to improve the performance of a memory bus performing graphics.

It is a second objective to provide a method of processing depth data in a memory device for reducing the time needed to modify and write spatial coordinate values to improve graphics performance, as well as improving the performance of a memory bus.

Accordingly, to achieve the first objective, the present invention provides a memory device including a memory cell array, and a data modifying circuit for comparing external depth data of a new object received from the memory controller with internal depth data of an existing object. The internal depth data is stored in the memory cell array. The comparison is done between the data having representing coordinates of the new object and of the existing object. The internal depth data is replaced by the external depth data depending on the result of this comparison.

To achieve the second objective, the present invention provides a method of processing depth data of an object in a memory device controlled by a memory controller. The method includes the steps of: receiving external depth data of a new object from the memory controller, storing the received external depth data, comparing the stored external depth data with corresponding internal depth data stored in the memory device, and storing the external depth data with which the internal depth data is replaced depending on the result of the comparison in the step. A status signal may be outputted to the memory controller, indicating that the internal depth data has been modified.

### BRIEF DESCRIPTION OF THE DRAWINGS

The above objectives and advantages of the present invention will become more apparent by describing in detail a preferred embodiment thereof with reference to the attached drawings in which:

FIG. 1 is a timing diagram for explaining a read-modify-write (RMW) operation of a memory device in the prior art;

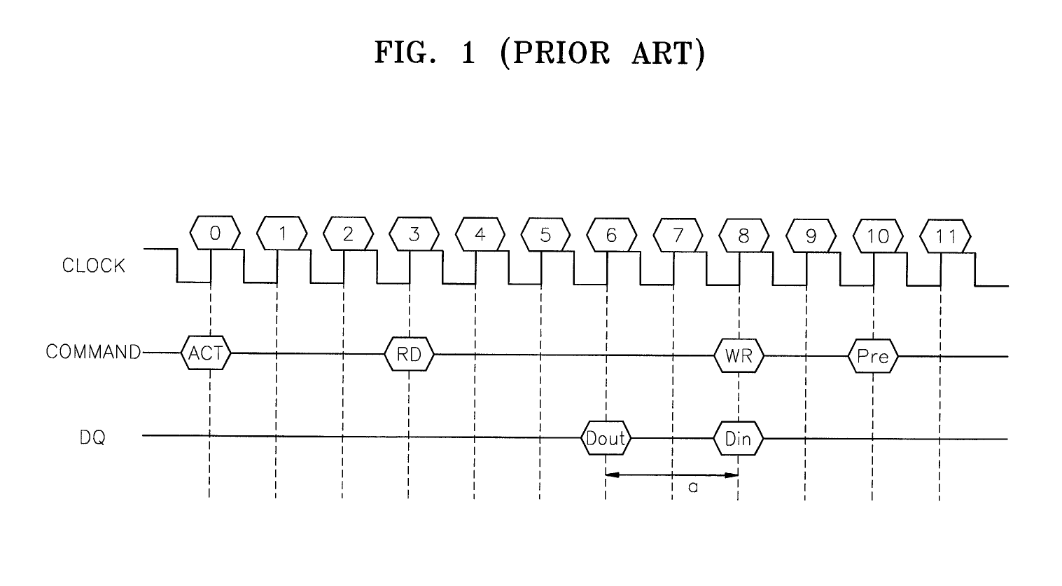

FIG. 2 illustrates a memory system including a memory device having a depth compare function according to an embodiment of the present invention;

FIG. 3 illustrates a detailed circuit for the memory device of FIG. 2;

FIG. 4 is a timing diagram illustrating a compare-read function according to an embodiment of the present invention; and

FIG. 5 is a flowchart for illustrating a method of comparing and reading depth data of an object in a memory device controlled by a memory controller according to an embodiment of the present invention.

### DETAILED DESCRIPTION OF THE INVENTION

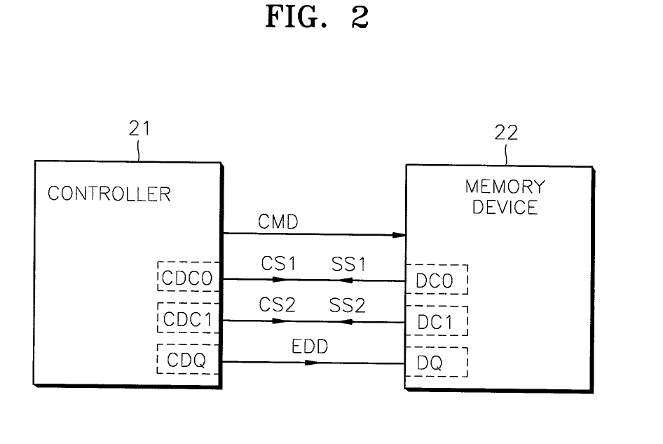

Referring to FIG. 2, a memory system includes a memory device 22 according to the present invention, and is controlled by a memory controller 21. A monitor is not shown.

Furthermore, FIG. 2 shows a flow of a command signal CMD, which is generated by the memory controller 21, and is transmitted to the memory device 22. Other signals are also sent through control pins DC0 and DC1 and a data I/O pin DQ. The memory controller 21 also generates an address, which selects a specific memory cell of the memory device 22.

Furthermore, the memory controller 21 generates and transmits to memory device 22 a first control signal CS1 and a second control signal CS2 through the control pins DC0 and DC1, respectively. Control signals CS1 and CS2 may be active or non-active (implemented by choosing high and low levels). The memory controller 21also prepares for writing external depth data through the data I/O pin DQ.

The memory device 22 is controlled by the memory controller 21. The monitor displays an object having depth data modified by the memory device 22. The memory controller 21 provides an interface for performing various controlling tasks of the monitor and of the memory device 22.

The memory device 22 generates and sends to the memory controller 21 a first status signal SS1 and a second status signal SS2. If the first and second status signals SS1 and SS2 are in an active state (also called “HIT”), the memory controller 21 determines that internal depth data has been replaced by the external depth data. On the other hand, if the first and second status signals SS1 and SS2 are in an inactive state (also called “MISS”), the memory controller 21 determines that internal depth data is maintained.

In a preferred embodiment of the invention, the control signals CS1, CS2, travel through the same conductors as the status signals SS1, SS2, even though they travel in opposite directions. For example, status signal SS1 may be transmitted through first control pin DC0, and status signal SS2 may be transmitted through second control pin DC1.

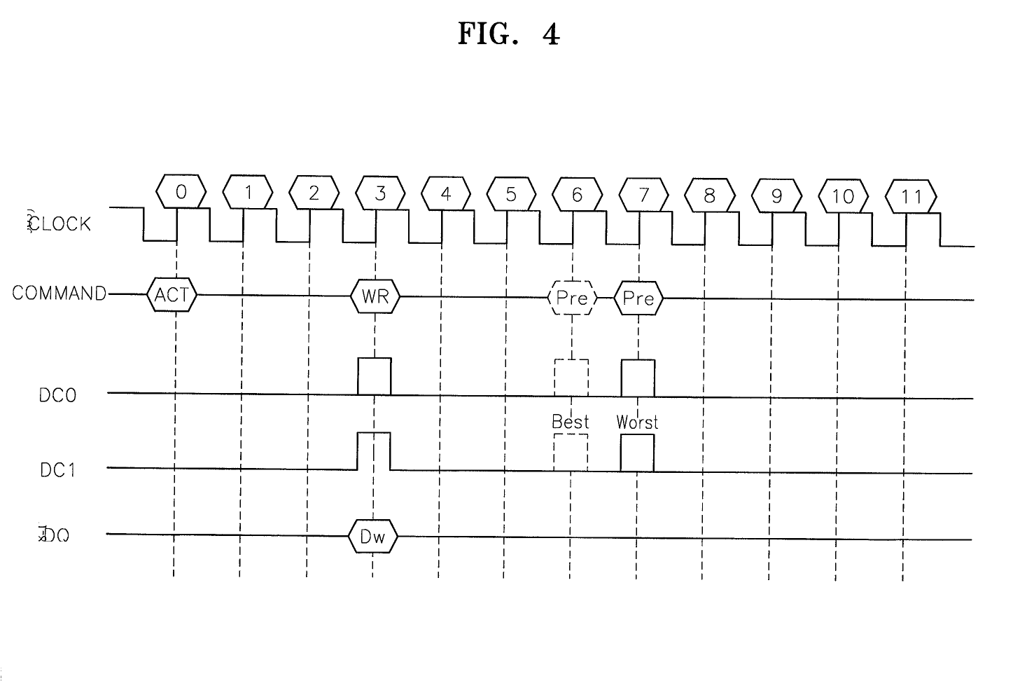

This generates an advantageous economy in the construction of the invention. The economy is made possible by the fact that the control signals CS1, CS2, are generated and transmitted at different times than the status signals SS1, SS2, as will become clear from FIG. 4 later in this document.

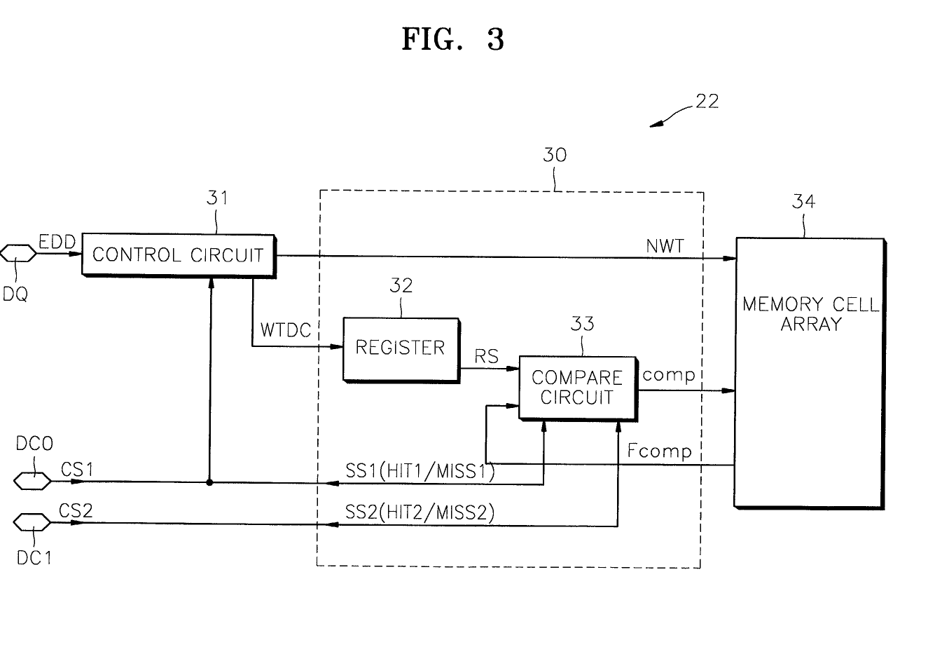

Referring to FIG. 3, a detailed circuit of the memory device 22 of FIG. 2 is shown, which is made according to an embodiment of the present invention. The memory device 22 includes a data modifying circuit 30, a control circuit 31, a memory cell array 34, first and second control pins DC0 and DC1, and a data I/O pin DQ. In particular, the data modifying circuit 30 further includes a register 32 and a compare circuit 33.

The control circuit 31 receives external depth data of a new object through signal EDD being received from the data I/O pin DQ. Circuit 31 then outputs the external depth data EDD as either WTDC or NWT, in response to a first control signal CS1. If the first control signal CS1 is in a non-active state, the external depth data NWT is output to the memory cell array 34 for normal writing. This bypasses the remaining structure. On the other hand, if the first control signal CS1 is in an active state, the external depth data WTDC is output to the register 32 for depth compare writing.

The register 32 stores the output signal WTDC of the control circuit 31, i.e., the external depth data. The compare circuit 33 compares the data of the coordinates of a new object, which is output as RS from the register 32, with internal depth data Fcomp of the corresponding coordinates of an existing object, the internal depth data being stored in the memory cell array 34, in response to the second control signal CS2. If the output RS of the register 32, i.e., external depth data RS, is smaller than the internal depth data Fcomp, the compare circuit 33 outputs the external depth data RS to the memory cell array 34 in order to modify the internal depth data Fcomp. According to another embodiment of the invention, if the output RS of the register 32, i.e., external depth data RS, is larger than the internal depth data Fcomp, the compare circuit 33 outputs the external depth data comp to the memory cell array 34.

The compare circuit 33 outputs at least one status signal to the memory controller 21. If the internal depth data Fcomp is modified as a result of this comparison, the status signal is a logic “high” signal HIT1 or HIT2. But if the internal depth data Fcomp is not modified, the status signal is a logic “low” signal MISS1 or MISS2.

FIG. 4 is a timing diagram when performing a compare-record function of the memory device 22 of FIG. 3 according to the present invention. A depth compare-write operation of the memory device 22 is now described in detail with reference to FIGS. 3 and 4. Referring to FIGS. 3 and 4, a depth compare-write command signal WR, first and second control signals CS1 CS2, and external depth data Dw, all of which are generated by the memory controller 21, are input into corresponding pins, i.e., a command pin (not shown), the first and second pins DC0 and DC1, and the data I/O pin DQ. This happens on the rise of the third cycle.

The control circuit 31 is now described. If the first control signal CS1 is in an active state when the write command signal WR is in an active state, the control circuit 31 outputs incoming external depth data WTDC to the register 32, in order to accomplish a depth compare-write function. Thus, the incoming external depth data EDD and the output signal WTDC of the control circuit 31 are the same. However, if the first control signal CS1 is in a non-active state, the control circuit 31 outputs the incoming external depth data NWT to the memory cell array 34 for writing.

Furthermore, if the first control signal CS1 is in an active state, the second control signal CS2 becomes important. In this case, the compare circuit 33 compares the internal depth data Fcomp within the memory cell array 34 with the output of the register 32, i.e., the external depth data RS.

Control signal CS2 becomes important as follows. If CS2 is in a non-active state, the compare circuit 33 compares the internal depth data Fcomp with the output of the register 32 in units of X bits, for example, 16 bits, where X is a natural number. But if the second control signal CS2 is in an active state, the comparison is in units of NX bits, for example, 32 bits if N is 2 and X is 16 where N and X are natural numbers.

As a result of comparing, the compare circuit 33 will write to the memory cell array 34 one of the two sets. In one embodiment it will be the set with the smallest depth values, and in another embodiment it will be the set with the largest depth values. This writing over the previous values has the effect of modifying the relevant stored values, if the different data has been overwritten.

The compare circuit 33 also issues status signals SS1, SS2, for reporting to the controller 21 whether the data has been changed or not. The status signals SS1, SS2 may be sent after only three (best case) or four (worst case) clock cycles lapse after issuing a depth compare-write command (which was performed in cycle 3). Accordingly, the whole process may be completed on the 6th or 7th cycle, as opposed to the 10 cycles needed by the prior art.

If the compare circuit 33 compares in units of X bits, and if the data has been modified, the first status signal SS1 is a logic “high” signal HIT1, indicating that the lower X bits of the internal depth data Fcomp have been modified through the first control pin DC0. Furthermore, the second status signal SS2 is logic “high” signal HIT2, indicating that the upper X bits of the internal depth data Fcomp have been modified through the second control pin DC1.

If the compare circuit 33 compares in units of NX bits, and if the data has been modified, the first status signal SS1 is a logic “high” signal HIT1, indicating that lower NX bits of the internal Fcomp have been modified. But if the depth data has not been modified, the first and second status signals SS1, SS2 are logic “low” signals MISS1 and MISS2, indicating that the internal depth data Fcomp is maintained.

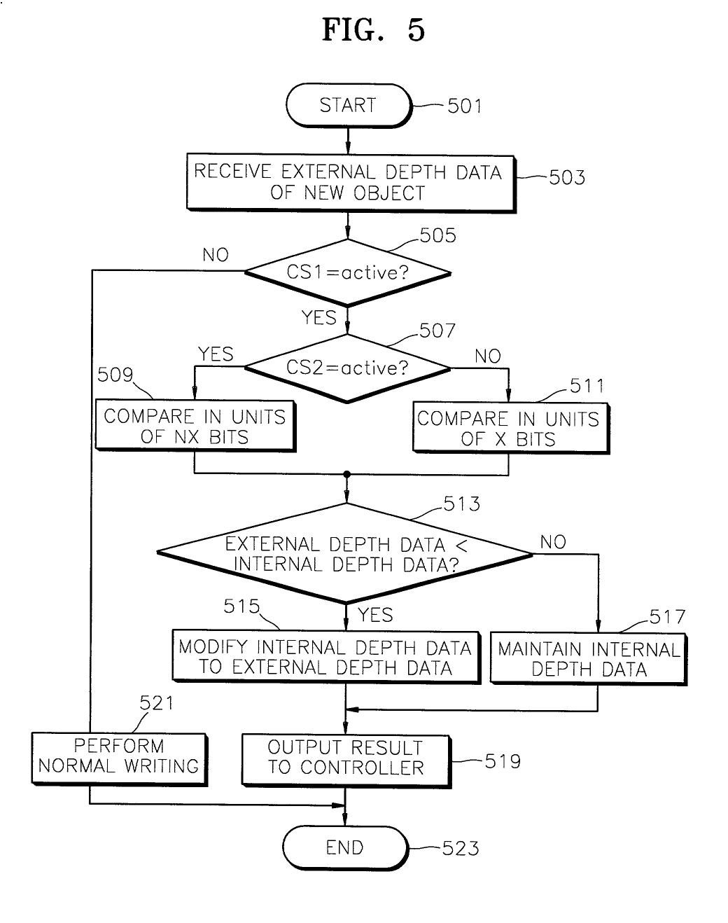

FIG. 5 is a flowchart showing a method of processing depth data of an object in the memory device 22 controlled by the memory controller 21, which starts from step 501. Referring also to FIGS. 2 and 3, in a step 503, the memory device 22 receives the external depth data EDD.

In step 505, the memory device 22 receives a first control signal CS1, and determines its state. If the first control signal CS1 is in a non-active state, then according to step 521, the control circuit 31 outputs the input external depth data EDD as data NWT to the memory cell array 34 within the memory device 22 for writing. But if the first control signal CS1 is in an active state, the control circuit 31 outputs external depth data EDD as data WTDC to the register 32.

In step 507, the memory device 22 receives a second control signal CS2, and determines its state. If the second control signal CS2 is in an active state, the compare circuit 33 compares the internal depth data Fcomp with the external depth data RS stored in the register 32 in units of NX bits (step 509). But if the second control signal CS2 is in an active state, the compare circuit 33 compares the internal depth data Fcomp with the external depth data RS in units of X bits (step 511).

In both instances, it is inquired whether the external depth data RS is smaller than the internal depth data Fcomp (step 513). If yes, the internal depth data Fcomp is modified to the external depth data RS (step 515). If not, the internal depth data Fcomp is maintained (step 517), and the external depth data RS is discarded. (In the equivalent embodiment, step 513 is the opposite, inquiring instead whether the external depth data RS is larger than the internal depth data Fcomp.)

According to a next step 519, the result of the comparison is output to the controller, and the process ends (step 523). The result of the comparison is expressed via status signals SS1, SS2. These can acquire values as described above. Logic “high” and “low” values may equivalently be chosen.

As has been described in the foregoing, according to the conventional art, at least ten clock cycles are required for one read-modify-write (“RMW”) operation. However, according to the present invention, only six (6) or seven (7) clock cycles are sufficient for performing one RMW operation, instead of the ten (10) required in the prior art. Therefore, the invention can improve performance by more than 30% compared with the prior art.

While this invention has been particularly shown and described with reference to preferred embodiments thereof, the illustrated embodiments are only examples, and it will be understood by those skilled in the art that various changes in form and details may be made therein without departing from the spirit and scope of the invention as defined by the appended claims.

What is claimed is:

1. A memory device for use with a memory controller, the memory device comprising:
a memory cell array adapted to store internal depth data of an object; and
a data modifying circuit distinct from the memory controller, the data modifying circuit being adapted to
receive corresponding new external depth data of the object from the memory controller,
compare the new external depth data with the internal depth data, and
write the external depth data in the memory cell array over the internal depth data depending on the result of the comparison.

2. The memory device of claim 1, wherein
the data modifying circuit is further adapted to output to the memory controller a status signal.

3. The memory device of claim 1, further comprising:
a first control pin for receiving a first control signal from the memory controller; and
a control circuit for transmitting the external depth data to the memory cell array thereby bypassing the data modifying circuit depending on a state of the first control signal.

4. The memory device of claim 3, wherein
the data modifying circuit is further adapted to output to the memory controller a status signal.

5. The memory device of claim 4, wherein
the status signal is output through the first control pin.

6. The memory device of claim 1, wherein the data modifying circuit includes
a register for storing the received new external depth data; and
a compare circuit for comparing the stored new external depth data with the internal depth data and for writing the external depth data in the memory cell array depending on the result of the comparison.

7. The memory device of claim 6, wherein
the compare circuit is further adapted to write the external depth data in the memory cell array if the external depth data is smaller than the internal depth data.

8. The memory device of claim 6, wherein
the compare circuit is further adapted to output a status signal to the memory controller.

9. The memory device of claim 6, further comprising:
a second control pin for receiving a second control signal from the memory controller,
wherein the compare circuit compares the internal depth data with the stored external depth data in units of X bits when the second control signal is in a non-active state, and in units of NX bits when the second control sign al is in an active state.

10. The memory device of claim 9, wherein
if the second control pin is in an inactive state, the compare circuit outputs to the memory controller:
a first status signal indicating that the lower X bits of the internal depth data have been modified, and
a second status signal indicating that the upper X bits of the internal depth data have been modified.

11. The memory device of claim 9, wherein
if the second control pin is in a non-active state, the compare circuit outputs to the memory controller a status signal indicating that NX bits of the internal depth data have been modified.

12. A method of processing depth data of an object in a memory device controlled by a memory controller, the method comprising the steps of:
(a) receiving external depth data of the object from the memory controller;
(b) storing the received external depth data;
(c) receiving a first control signal from the memory controller through a first control pin distinct from the memory controller;
(d) determining a state of the first control signal; and
(e) if the state of the first control signal is determined to be inactive, writing the external depth data to a memory cell array within the memory device,
(f) elseif the state of the first control signal is determined to be active, comparing the stored external depth data with corresponding internal depth data stored in the memory cell array, and writing the external depth data over the corresponding internal depth data in the memory cell array depending on the result of the comparison.

13. The method of claim 12, wherein
step (f) further includes outputting to the memory controller a status signal indicating that the internal depth data has been modified.

14. The method of claim 12, wherein
writing in step (f) takes place if the comparison yields that the external depth data is smaller than the internal depth data.

15. The method of claim 12, wherein
writing in step (f) takes place if the comparison yields that the external depth data is larger than the internal depth data.

16. The method of claim 12, further comprising:
(g) receiving a second control signal from the memory controller through a second control pin distinct from the memory controller;
(h) determining a state of the second control signal; and
(i) if the state of the second control signal is determined to be inactive, comparing the internal depth data with the stored external depth data in units of X bits,
(j) elseif the state of the second control signal is determined to be active, comparing the internal depth data with the stored external depth data in units of NX bits.

17. The method of claim 16, wherein step (i) further includes
outputting to the memory controller a first status signal indicating that the lower X bits of the internal depth data have been modified, and
outputting to the memory controller a second status signal indicating that the upper X bits of the internal depth data have been modified.

18. The method of claim 17, wherein
the first status signal is output through the first control pin, and
the second status signal is output through the second control pin.

19. The method of claim 16, wherein step (j) further includes
outputting to the memory controller a status signal indicating that the NX bits of the internal depth data has been modified.

20. The method of claim 19, wherein
the status signal is output through one of the first and second control pins.
